(19) United States
(12) Patent Application Publication
(10) Pub. No.: US 2017/0022401 A1
(43) Pub. Date: Jan. 26, 2017

(54) HEAT-ACTIVATED ADHESIVE COMPOSITION

(71) Applicant: ACTEGA Radcure, Inc., Cinnaminson, NJ (US)

(72) Inventor: John ARNOLD, Pittstown, NJ (US)

(21) Appl. No.: 14/806,987

(22) Filed: Jul. 23, 2015

(51) Int. Cl. C09J 133/14; B05D 3/06

(52) U.S. Cl. CPC C09J 133/14; B05D 3/067

(57) ABSTRACT

A high solids radiation-curable coating comprises at least one acrylated oligomer component and a component soluble in the acrylated component that solidifies when the acrylated coating cures. The coating dries upon radiation cure and remains dry to a temperature of at least 60° C. and is bondable at a higher temperature. The formulations have significant utility as a dry to the touch adhesive that can be applied to a wide variety of substrates, and has particular applicability in the printing industry.

The present application is a continuation of application Ser. No. 13/613,762 filed Sep. 13, 2012, in turn a continuation of application Ser. No. 12/357,507 filed Jan. 22, 2009.

The present invention relates to a curable thermoplastic acrylic formulation having significant utility as an adhesive, such as in the printing industry.

### BACKGROUND OF THE INVENTION

Water based thermoplastic acrylic formulations have utility as adhesive coatings that, as applied to a substrate, can dry to the touch, allowing the coated substrates to be stacked without bonding to each other. Such formulation technology is useful for allowing film or board stock to be printed and so coated as part of the printing process and then rolled up or stacked. The coated product has good storage resistance and can be shipped without fear that the stack or roll will self-adhere. The coated films or board can be unwound or unstacked at another facility and then used in various heat seal constructions, such as the heat seal application of PVC films to board stock “blister boards”; keeping heat shrink labels adhered to and prevented from sliding on bottles during a heat shrink process; laminating PVC films and press polished elements in layered credit cards; creating “label-less” labels by reverse printing onto a release film and topping with the heat sealable layer which would become the base of the label; and many other printing and packaging applications where there is a need to adhere two surfaces together that, without the presence of the subject adhesive, would not otherwise bond together with the application of heat and usually pressure.

Water-based acrylics are mainly thermoplastic; that is, they melt and flow when heated; they also have a few heat reactive sites that may crosslink or bond to other surfaces when heated. The adhesive is applied to the substrate and subsequently activated by heat. The adhesive formulation is typically applied in liquid form to the substrate and then is allowed to dry, and may require a large amount of energy to remove the water quickly in order to achieve a dry coating condition. The drying of such coating formulations to the dry-touch condition on non-water absorbent substrates, such as plastics, plastic films or film-coated board, can be especially slow, since the water-impermeable substrate does not assist in drawing the water from the coating. In such cases the water must thus be boiled or evaporated off. Not surprisingly, water based acrylics dry very fast on cardboard and very slow on non-porous substrates such as plastics. In addition to the time required, the evaporation process is energy intensive, and further limits the attractiveness of use of such water based formulations on plastic and the like substrates.

Radiation curable resins have the advantage of the ability to rapidly cure with the application of very little energy, and exhibit the rapid cure on all films and board stock substrates. UV curable coatings are well known, but are normally thermosetting. Thermosetting polymers do not melt and flow, so by heating a UV curable coating one would not expect it to melt, flow, or bond an adjacent surface during or after application of heat and pressure. Therefore the greatest concern in the area of energy curable adhesives and coatings is that when these materials polymerize to a tack free surface they typically are thermoset resins that have been irreversibly cured and thus cannot be subsequently activated as needed to serve as heat seal adhesive. If the crosslink density is dropped, one normally ends up with a pressure sensitive adhesive (PSA) or near pressure sensitive adhesive that cannot be stacked or rolled without blocking or having an unwanted affinity to its own stock. The addition of a release liner, which would permit the use of a PSA as a form of delayed bonding adhesive, is an additional expense since it creates an undesirable waste that must be removed prior to application. Indeed PSAs, including UV/EB energy curable PSAs, are widely used in adhesive applications but cannot be used when a tack free surface is required or where a release coating cost or removal is less effective than a heat seal adhesive for certain types of adhesive applications.

The printing industry continues to evolve to more energy efficient and faster printing presses with higher quality. As a result, more and more presses are built using UV curing lamp systems as the primary drying/curing mechanism. Many presses built in the last five years no longer have a thermal oven/dryer for removing water or solvent from an ink or coating, so it is necessary to supply the printing industry with products that enable the use of UV curing system equipped presses to produce heat seal adhesive coated products, that prior to the present invention, was not possible.

Radiation curable coatings are also considered environmentally friendly coatings, as they generally contain little or no volatile organic compounds (VOCs) and it is possible to formulate and apply these coatings without generating significant solvent emissions during processing. This is a very important for compliance with recent stricter emission standards set forth by federal and local environmental protection agencies. Radiation curable coatings are easily formulated to contain less than 3% VOC or greater than 97% solids content. The measurement of coating solids refers to the mass of coating remaining after curing/drying as compared with the original weight in the liquid or unapplied state. High solids coatings and adhesives have a further advantage in that it is much easier to achieve higher adhesive coating weights with standard printing presses, unlike lower solids water- and solvent-diluted coatings which require special equipment to both apply a heavier coat weight and then dry off the water or solvent.

It is accordingly a purpose of the present invention to provide a high solids, and preferably >97% solids, radiation curable coating that serves as a dry to the touch adhesive that can be applied to a wide variety of substrates.

It is a further purpose of the present invention to provide a radiation curable coating that cures rapidly and requires little applied energy to cure.

It is a further purpose of the present invention to provide a radiation-curable coating that yields a dry, stackable surface that will not block at temperatures of up to about 60° C., but will provide a rapid bond when heated to over 100° C. and pressed against a surface to be bonded.

### BRIEF DESCRIPTION OF THE INVENTION

In accordance with the foregoing, the present invention avoids the reduction of cross-link density in a radiation curable coating composition that would result in the formation of a PSA or near PSA coating. Rather, the invention includes a solid component that does not crosslink in a thermoset resin formulation. The solid component has a melting point low enough to flow when heated during the intended bonding process, but not so low that the coating will block during normal storage. Preferably, the solid component will also have the ability to flow into, but not necessarily itself bond to, the mating material, such as a plastic, that is being heat bonded to. The curing can be initiated by either actinic radiation, electron beam irradiation or other equivalent processes, all of which shall be referred to as “radiation”.

### DETAILED DESCRIPTION OF PREFERRED EMBODIMENTS

A fuller understanding of the invention will be obtained upon consideration of the following detailed but nonetheless illustrative embodiments of the invention.

The invention utilizes the fact that many acrylated oligomers, and particularly urethane oligomers as well as other low transition temperature oligomers, get sticky or tacky when heated. The combination of a resin component having this tack feature and a low melting point solid material yields a heat sealable composition that wets, flows and adheres to a wide range of materials, including plastics. It is surprising that the addition of such a solid, which itself neither bonds to either substrate nor is sticky when wet, is so effective at producing a good bond.

The solid material is preferably a plasticizer, such as triphenylphosphate. Other plasticizers with a melting point between 40° C. and 200° C. may also be appropriate for use as the solid material. Preferably the melting point falls between 50-120° C., and the plasticizer may be present at concentrations from 1-30%, preferably between 2 and 10% by weight. Other appropriate plasticizers include triphenyl phosphate, pentaerythritol tetrabenzoate, and 1,4-cyclohexane dimethanol dibenzoate. Other potential solid materials include polyols, low melting point epoxy, vinyl and acrylic resins, acrylic copolymers, vinyl acetate resins, fatty acids and fatty acid esters, and typical tackifier resins which include rosins, rosin esters, and hydrocarbon resins.

The following Table 1 present two formulations, A and B, differing only in that Formula B, in accordance with the present invention, includes triphenylphosphate, OP(OC₆H₅)₃. The formulations, with the exception of the triphenylphosphate, are of conventional nature for a polymer coating. The aromatic polyester urethane acrylate oligomer is the primary resin component. IRGACURE 184, a product of Ciba Specialty Chemicals, is a photoinitiator, the component that absorbs the initiating radiation to generate a reactive species which initiates the polymerization or cure. The synergist is present to facilitate the first cure. It is to be recognized that a photoinitiator may not always be necessary, particularly when the formulation is electron beam curable. SR 212 is a difunctional monomer product of Sartomer Co., Eton Pa., 1,3-butylene glycol diacrylate.

TABLE 1

| | Formula | Formula |
|---|---|---|
| Component | A | B |
| acrylated amine synergist | 15 | 15 |
| SR 212 | 20 | 20 |
| triphenylphosphate | 0 | 5 |
| aromatic polyester urethane | 60 | 60 |
| acrylate oligomer | | |
| IRGACURE 184 | 5 | 5 |

Pieces of 10-mil thick cardboard were coated with either Formula A or B using a 200 line/inch anilox hand proofer, which lays a 0.2-mil coating. The coatings were cured with a 300 W/in UV lamp equipped with a Fusion H-bulb. The pieces were exposed to the UV light on a conveyor running at 110 ft/min. Both coatings were cured upon exposure to the light. The cured Formula A coating had a light tack, while Formula B cured dry to the touch. Additional cure or slower cure (50 ft/min) for more UV exposure did not remove the light tack from pieces coated with Formula A.

The coated pieces were stacked and placed in an oven at 140° F. overnight. Upon subsequent inspection the pieces coated with Formula A were stuck together, while those coated with Formula B were not. Such results are important and demonstrate that the addition of the triphenylphosphate improves the safe storage capability of the Formula B-coated board. This is a significant benefit of the formulation as it allows, for example, for the stable shipment of such coated stock or substrate from one location to another. The cargo areas of standard commercial trucks can reach 140° F. during shipping. If a coated stock sticks together during transit, it no long can be used for heat sealing applications.

The ability of the two formulas to heat seal was also compared. Since A has a light tack, one might expect A to stick and heat seal to a film better than B; surprisingly such was not the case. Two films were used—a 1-mil thick PVC (a generic polyvinyl chloride film) and 2-mil thick polypropylene film (PRIMAX brand from Avery Dennison). Heat was applied with a Packwood heat seal machine, model PW3016-440-1-22-0. 182° C. heat was applied through the board side of the lamination for 4 seconds to a ⅜-inch wide strip across the board. The remaining film saw no heat and was not bonded. Testing for heat seal was conducted by lifting and pulling on the unbonded portion of the film. With Formula A the heat-sealed area of the film had light adhesion and lifted from the board in a manner of a tape lifting from the board. No coating adhered to on the film. With Formula B the heat sealed area of the board stuck to the film and was torn from the board, demonstrating a strong heat seal bond.

It may be beneficial that at least one of one of the acrylated components has the ability to crosslink with heat after curing. This can produce a stronger bond during the heat seal process and can enables the coating to crosslink to the plastic or other material being bonded as well as becoming wet and bonding to the plastic. With respect to the formulation above, this can be accomplished by the addition of a vinyl or acrylic resin having the desired property. To assist in the spread or flow of the formulation over the substrate, an appropriate wetting agent may also be added. A representative formulation thus may be as set forth in the following Table 2:

TABLE 2

| Component | Preferred | Lower | Upper |
|---|---|---|---|
| acrylated amine synergist | 18 | 5 | 40 |
| N,N dimethylacrylamide | 29 | 20 | |
| triphenylphosphate | 5 | 1 | 40 |
| aromatic polyester urethane | 39 | 20 | 60 |
| acrylate oligomer | | | |
| photoinitiator(s) | 8 | 2 | 12 |
| wetting agent | 1 | 0 | 2 |
| vinyl or acrylic resin | 0 | 0 | 15 |

The “best” formula presents amounts in weight percent, adding to 100%. The lower and upper limits represent bounding weight percentages for the associated components. Within the broad ranges, where the acrylated oligomer is a polyester urethane acrylate, a 5-70% is preferred, and a 25-50% is of greater preference. Examples of suitable urethane acrylates include Cytech Products Inc's 4800 and 8800 series, Polymer Systems' PURLAST 100 and 500 series, Rahn USA's 4000 series, and Sartomer's ACTILANE 100 and CN-900 series resins.

The present invention appears to have broad applicability over a wide range of oligomer resin formulations, including those with monomer components. Inclusion of a monomer lowers viscosity and may also improve adhesion of the composition to the substrate to which it is applied for initial radiation cure. The monomers may be mixtures of mono- and multi-functional components, and can be diacrylates, (meth)acrylates, vinyls, or acrylamides, including amine synergists or acrylated amine synergists. The synergists may be present at a weight percentage of 10-70%, more preferably 40-70%, and may advantageously include N,N-dimethylacrylamide and an amine functional acrylate. Other appropriate synergists include those offered by Rahn USA under its 5000 series, Sartomer's CN 300 and CN 500 series, and Cytech Products' EBECRYL 700 and 7000 series. As the specific formulations of such synergists are often proprietary, they may chosen based upon viscosity and general formulation to adjust both the viscosity and cure speed for the overall composition. In general, the synergist will promote a speedier and fuller cure.

Another representative formula is presented in the following Table 3:

TABLE 3

| | Wt % |
|---|---|
| acrylated amine synergist | 16 |
| N,N dimethylacrylamide | 21 |
| Monomer | 8 |
| triphenylphosphate | 2.5 |
| aromatic polyester urethane | |
| acrylate oligomer | 36.5 |
| Photoinitiators | 10 |
| wetting agent | 1 |
| vinyl or acrylic resin | 5 |

This formulation includes an additional monomer (“monomer”), such as Hexion Specialty Chemicals' ACE brand hydroxyl acrylate monomer, which serves as a diluent to speed cure to the composition without sacrifice of adhesion. Other monomers that may be of significant utility include n-vinylpyrrolidone, n-vinylcaprolactam, acrylic acid, acryloyl morpholine, and tetrahydrofurfuryl acrylate. Inclusion of a vinyl or acrylic resin, such as a modified vinyl pyrrolidone, may improve the heat sealing properties of the composition. LUVITEC VA 64, a product of BASF SE, is of particular value.

I claim:

1. A radiation-curable adhesive coating, comprising:
at least one acrylated oligomer component; and
a component soluble in the acrylated component that solidifies when the acrylated coating cures,
such that the coating dries upon radiation cure and remains dry to a temperature of at least 60° C. and is bondable at a higher temperature, the coating being free of additional tackifier or surfactant components.

2. The coating of claim 1, further comprising a photoinitiator.

3. The coating of claim 1, wherein the acrylated oligomer is a polyester or a polyurethane.

4. The coating of claim 1, wherein the acrylated oligomer is a polyester urethane acrylate.

5. The coating of claim 4, wherein the polyester urethane acrylate is present at a weight percentage of 5-70 percent.

6. The coating of claim 5, wherein the polyester urethane acrylate is present at a weight percentage of 25-50 percent.

7. The coating of claim 1 further comprising a monomer.

8. The coating of claim 7 wherein the monomer is chosen from the group consisting of (meth)acrylates, vinyls, and acrylamides.

9. The coating of claim 1 where the soluble solid is a plasticizer with a melting point between 40° C. and 200° C.

10. The coating of claim 1 wherein the plasticizer has a melting point of 50-120° C.

11. The coating of claim 1 wherein the plasticizer is present at a concentration of 1-30% by weight.

12. The coating of claim 1 wherein the plasticizer is present at a concentration of 2-10%.

13. The coating of claim 1 wherein the soluble component is chosen from the group comprising triphenyl phosphate, pentaerythritol tetrabenzoate, and 1,4-cyclohexane dimethanol dibenzoate.

14. A method of forming a heat activated adhesive coating for a substrate, comprising the steps of:
forming a radiation-activated adhesive composition having at least one acrylated oligomer component and a component soluble in the acrylated component that solidifies when the composition cures;
applying the composition to the substrate in the form of a coating; and
radiation-curing the composition such that the composition dries and remains dry to a minimum temperature of at least 60° C.

15. The method of claim 14 further comprising the step of bonding the dried composition to another substrate at a temperature above the minimum temperature to affix the two substrates together.

16. The method of claim 14 wherein the soluble component is chosen from the group of triphenylphosphate, triphenyl phosphate, pentaerythritol tetrabenzoate, and 1,4-cyclohexane dimethanol dibenzoate.

17. A radiation-curable coating, comprising:
an acrylated amine synergist;
N,N dimethylacrylamide;
triphenylphosphate;
an aromatic polyester urethane acrylate oligomer; and
a vinyl or acrylic resin.

18. The radiation-curable coating of claim 17, wherein:
the acrylated amine synergist is present in an amount of about 16% weight percent;
N,N dimethylacrylamide is present in an amount of about 20 to 29% weight percent;
triphenylphosphate is present in an amount of about 2.5% weight percent;
the aromatic polyester urethane acrylate oligomer is present in an amount of about 36.5% weight percent;
the vinyl or acrylic resin is present in an amount of about 5% weight percent, and
a monomer is present in an amount of about 8% weight percent.
